(19) United States
(12) Patent Application Publication
(10) Pub. No.: US 2016/0128373 A1
(43) Pub. Date: May 12, 2016

(54) APPARATUS AND PROCESSES FOR EXTRACTING AND DISTRIBUTING READY TO DRINK BEVERAGES

(71) Applicant: Pressed Juicery, LLC, Santa Monica, CA (US)

(72) Inventors: Jill Elaine Costelow, Clovis, CA (US); Fernando Garibay, Parlier, CA (US); Emily Verwey, Fresno, CA (US)

(21) Appl. No.: 14/936,603

(22) Filed: Nov. 9, 2015

Related U.S. Application Data
(60) Provisional application No. 62/078,395, filed on Nov. 11, 2014.

(51) Int. Cl. A23L 2/04; A23L 2/72; A23B 7/10

(52) U.S. Cl. CPC A23L 2/04; A23B 7/10; A23L 2/72; A23V 2002/00

(57) ABSTRACT

An apparatus and processes for extracting juices from produce and efficiently distributing the juices are presented. The apparatus and processes are generally directed to a process that involves receiving and handling of produce; sorting and trimming the produce; weighing and batching the produce; disinfection of the produce; extraction of juice from the produce using a screw type press; filtration of the juice; mixing/blending of juice, packaging the final juice in bulk bags, where all the steps are performed in the refrigerated state at which the produce was received. Using bulk bags for packaging and subjecting the bulk bags to High Pressure Processing ensures food safety and significantly reduces the cost of distribution to remote locations worldwide. Bottling may be performed at the remote locations prior to local distribution.

### CROSS-REFERENCE TO RELATED APPLICATIONS

The present application claims the benefit of U.S. Provisional Application Ser. No. 62/078,395, filed on Nov. 11, 2014, specification of which is herein incorporated by reference for completeness of disclosure.

### BACKGROUND OF THE INVENTION

### Field of the Invention

Embodiments of the invention relates to the field of juice extraction. More specifically, the invention relates to method and apparatus for extracting and packaging ready to drink beverages for efficient distribution.

### BRIEF SUMMARY OF THE INVENTION

One or more embodiments of the invention are directed a process and apparatus for extracting and packaging ready to drink beverages for efficient distribution using bulk bags. The current invention's method of shipping in bulk bags provides significant cost advantage and facilitates worldwide shipping over the current industry practice of shipping ready to drink juices in bottles.

One or more embodiments of the invention are directed to a method for extracting ready to drink juices from produce. The method is generally directed to a process that involves receiving and handling of produce; sorting and trimming the produce; weighing and batching the produce; disinfection of the produce; extraction of juice from the produce; filtration of juice; mixing/blending of juice; and packaging of the final juice product for distribution.

In one or more embodiments, the juice extraction assembly comprises a receiving station for produce. The process of receiving and handling is the initial step and generally involves receiving and maintaining the produce in the state in which it was received. For instance, refrigerated produce is received and maintained in the refrigerated state; frozen produce is received and maintained in the frozen state; and dry goods are received and maintained at ambient temperatures.

In one or more embodiments, the juice extraction assembly comprises a sorting station. The sorting and trimming step is performed to ensure the produce juiced meets quality specifications. Depending on the flavor profile of the juice the produce will receive different preparation. For example, the rind is separated from the meat for Classic watermelon. However, for other watermelon beverages, the whole watermelon rind and meat may be juiced.

One or more embodiments of the present invention further comprise a disinfection station. The disinfection station is preferably a cold refrigerated environment. During this step, the produce may be disinfected using traditional PAA (Peracetic acid) methods and then placed into a grinder directly above the cold press.

One or more embodiments of the present invention further comprise a feedstock station wherein the weighing and batching of produce is performed. The weighing and batching step provides a starting estimated produce weight based on expected yield of raw produce for the extracted juice. However, the juice extraction process continues to run with additional feedstock until the expected yield of juice needed for the juice blends is obtained. Preferably, each individual produce is juiced separately and then combined as needed to make juice blends.

One or more embodiments of the present invention further comprise a juice extraction station. The juice extraction station is preferably a cold refrigerated environment. The juice extraction station comprises a produce grinder as the cold press. The produce grinder is preferably a high pressure screw type device, e.g., the CP and KP series screw presses from Vincent Corporation. One or more embodiments comprise stainless steel single screw and twin screw system with a large-hole screen to separate the juice from the pulp under pressure. The process is a continuous feed system compared to prior art systems that use a batch accordion style bag press system.

Citrus produce can be either cold pressed or cold extracted. Traditional juice extractors that are typical in the industry for pasteurized juice may be used for cold extraction.

One or more embodiments of the present invention further comprise a filtering station. The filtering station comprises a vibratory filter system that uses various size mesh screens to filter the juice using gravity and/or pressure. The filtering station comprises a gentle filtering process that minimizes off flavor profiles from high pressure on the juice pulp. Depending on the desired clarity of the final juice product, the juice may also be put through a mesh sock filter.

One or more embodiments of the present invention further comprise a mixing/blending station. At the mixing/blending station, juices may be mixed together based on a formula. The mixed juices may be tasted and adjusted to match certain flavor profile by adding small amounts of the juices and ingredients as needed. Master Tasters may be used to make final decisions on juice profiles.

One or more embodiments of the present invention further comprise a packaging station. At the packaging station, the juices are placed in bulk bags, e.g. Bag-in-Box; and subjected to High Pressure Processing (HPP) prior to refrigerated shipment to remote facilities for final bottling and distribution.

### BRIEF DESCRIPTION OF THE DRAWINGS

The above and other aspects, features and advantages of the invention will be more apparent from the following more particular description thereof, presented in conjunction with the following drawings wherein:

FIG. 1 is an illustration of an exemplary juice extraction process flow for refrigerated goods in accordance with one or more embodiments of the present invention.

FIG. 2 is an illustration of an exemplary Bulk Bag packaging process in accordance with one or more embodiments of the present invention.

FIG. 3 is an illustration of an exemplary freeze process flow for frozen goods in accordance with one or more embodiments of the present invention.

FIG. 4 is an illustration of an exemplary dry goods extraction process in accordance with one or more embodiments of the present invention.

FIG. 5 is an illustration of an exemplary CP Series Screw Press from Vincent Corporation employed in one or more embodiments of the present invention.

FIG. 6 is an illustration of an exemplary KP Series Screw Press from Vincent Corporation employed in one or more embodiments of the present invention.

FIG. 7 is an illustration of an exemplary SILVERSON GDD30 Duplex Dissolver Batch Mixer employed in one or more embodiments of the present invention.

FIG. 8 is an illustration of an exemplary hybrid produce extraction process in accordance with one or more embodiments of the present invention.

### DETAILED DESCRIPTION

The present invention comprising method and apparatus for extracting and efficiently distributing ready-to-drink beverages, freeze and toppings will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. Furthermore, although steps or processes are set forth in an exemplary order to provide an understanding of one or more systems and methods, the exemplary order is not meant to be limiting. One of ordinary skill in the art would recognize that the steps or processes may be performed in a different order, and that one or more steps or processes may be performed simultaneously or in multiple process flows without departing from the spirit or the scope of the invention. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

For a better understanding of the disclosed embodiment, its operating advantages, and the specified object attained by its uses, reference should be made to the accompanying drawings and descriptive matter in which there are illustrated exemplary disclosed embodiments. The disclosed embodiments are not intended to be limited to the specific forms set forth herein. It is understood that various omissions and substitutions of equivalents are contemplated as circumstances may suggest or render expedient, but these are intended to cover the application or implementation.

The term “first”, “second” and the like, herein do not denote any order, quantity or importance, but rather are used to distinguish one element from another, and the terms “a” and “an” herein do not denote a limitation of quantity, but rather denote the presence of at least one of the referenced item.

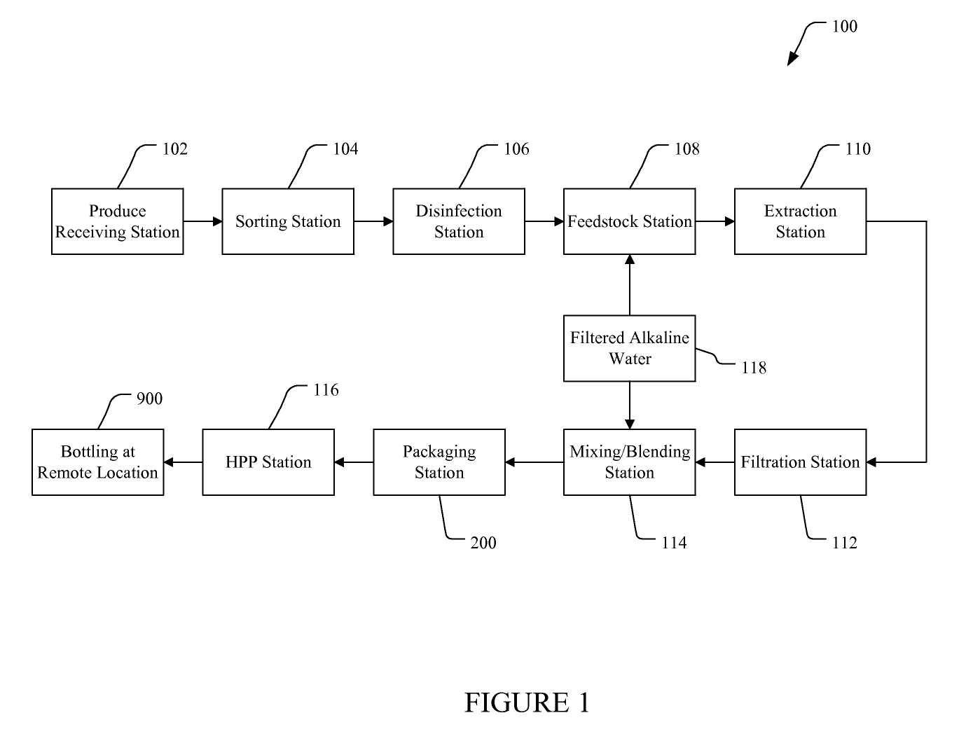

One or more embodiments of the present invention will now be described with references to FIGS. 1-9.

FIG. 1 is an illustration of an exemplary juice extraction process flow 100 for refrigerated goods in accordance with one or more embodiments of the present invention. As illustrated process 100 comprises produce receiving station 102; sorting and trimming station 104; disinfection station 106; feedstock station 108; extraction station 110; filtration station 112; mixing/blending station 114; packaging station 200; and HPP station 116. The steps of process 100 are preferably performed in a refrigerated state.

In one or more embodiments, the receiving and handling station 102 is the initial step and generally involves receiving and maintaining refrigerated goods, e.g. apple and other produce, in the state in which it was received. For instance, refrigerated produce is generally received and maintained at temperatures between about 30° F. and about 38° F. Preferably, refrigerated produce is maintained at a temperature of about 34° F.

In one or more embodiments, the juice extraction assembly feeds the received produce to a sorting station 104 where sorting and trimming of the produce may be performed as needed to ensure the resulting juice meets quality specifications. At sorting station 104, the produce is further prepared depending on the desired flavor profile of the resulting juice. For example, the rind is separated from the meat for Classic watermelon beverage. However, for other watermelon beverages, the whole watermelon, i.e. rind and meat, may be included for juicing.

In one or more embodiments of the present invention, the sorting station 104 feeds the refrigerated produce to a disinfection station 106. The disinfection station is preferably a cold refrigerated environment. During this step, i.e. 106, the produce may be disinfected using traditional PAA (Peracetic acid) methods. Those of skill in the arts would appreciate that other methods of disinfecting the produce may be employed without deviating from the spirit of the invention.

In one or more embodiments of the present invention, the disinfection station 106 feeds the sorted produce to a feedstock station 108 for weighing, batching and mixing of the produce as needed. Filtered water 118, preferably alkaline, may be added to the produce at feedstock station 108. The weighing and batching step provides a starting estimated produce weight based on expected yield of raw produce for the extracted juice. However, the juice extraction process continues to run with additional feedstock until the expected yield of juice needed for the juice blends is obtained. Preferably, each individual produce is juiced separately and then combined as needed to make juice blends.

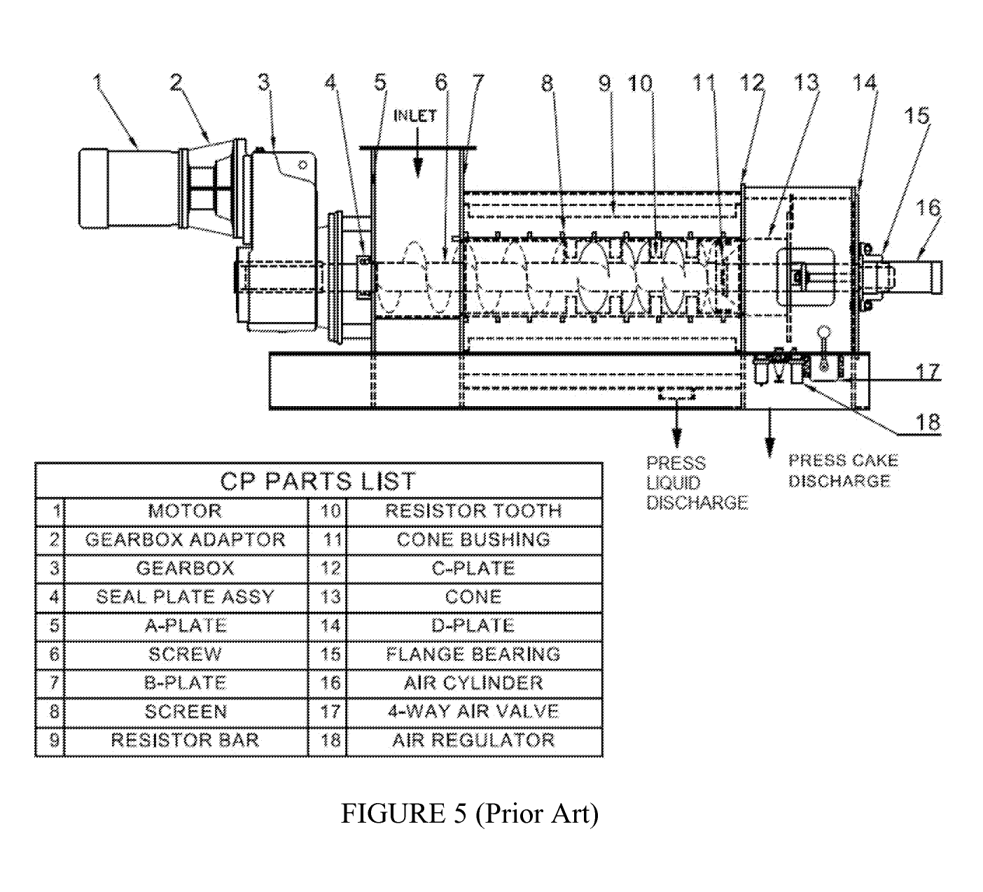

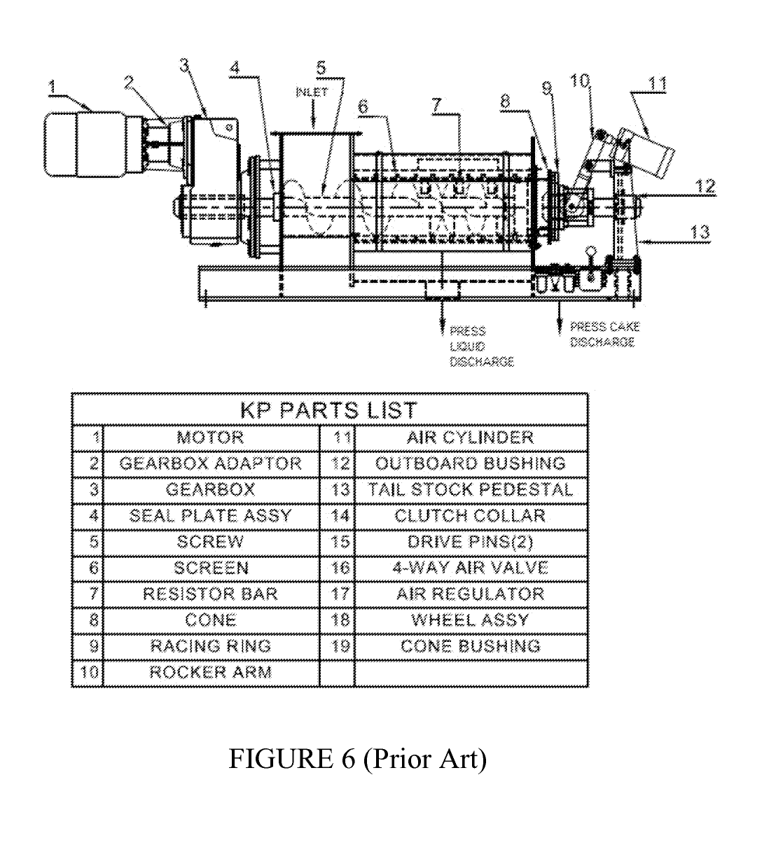

In one or more embodiments of the present invention, the produce from feedstock station 108 is fed to a juice extraction station 110. The juice extraction station is preferably a cold refrigerated environment. The juice extraction station 110 comprises a produce grinder. The produce grinder is preferably a high pressure screw type device, e.g., the CP Series Screw Press (illustrated in FIG. 5) and KP Series Screw Press (illustrated in FIG. 6), both from Vincent Corporation. One or more embodiments of the invention use a stainless steel single screw and twin screw press system with a large-hole screen to separate the juice from the pulp under pressure. The extraction process 110 is a continuous feed system compared to prior art systems that use a batch accordion style bag press system. It should be obvious to those of skill in the art that other high pressure screw type presses may be employed without deviation from the spirit of the present invention.

In one or more embodiments, the pressure ranges for the screw press varies from about 20 psi to about 100 psi, depending on produce. Speed settings range from about 1800 rpm to about 2880 rpm.

In one or more embodiments of the present invention the juice extraction station 110 cascades with gravity to a vibratory filtering station 112. The vibratory filtering station uses various size mesh screens to filter the juice using gravity and/or pressure. An exemplary screen for the filtering station may be a SWECO model, for instance. The filtering station employs filtering screens ranging from about 50 mesh (300 micron) to about 300 mesh (50 micron), depending on produce. With these mesh sizes, the filtering station provides a gentle filtering process that minimizes off flavor profiles from high pressure on the juice pulp. Depending on the clarity of the final juice the juice may also be put through a mesh sock filter. The mesh sock filtering is preferably with about 150 mesh (100 micron) screens.

In one or more embodiments of the present invention the filtering station 112 feeds to a mixing/blending station 114. At the mixing/blending station, 114, different juices may be mixed together, mixed with filtered water 118 or with other products, based on a formula. The mixed juices may be filtered again using the apparatus of step 112, tasted and adjusted to match certain flavor profile by adding small amounts of the juices and ingredients as needed. Master Tasters may be used to make final decisions on juice profiles.

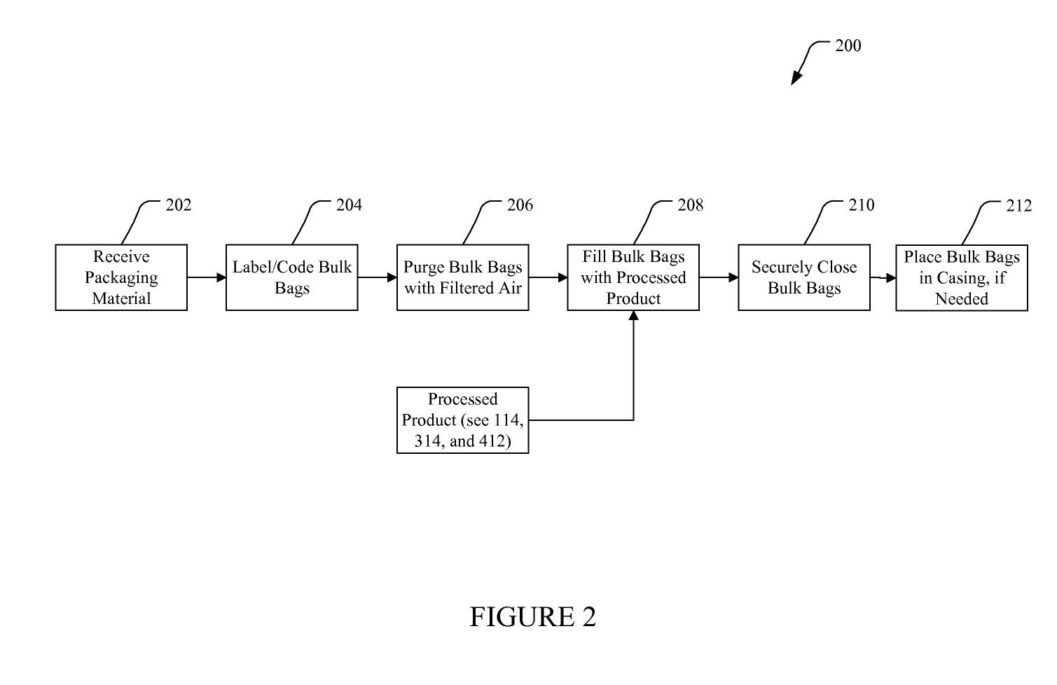

In one or more embodiments of the present invention, the final juice product is fed to a packaging station 200. FIG. 2 is an illustration of an exemplary bulk bag packaging process 200 in accordance with one or more embodiments of the present invention. As illustrated, bulk bag packaging process 200 comprises packaging material receiving station 202; Bulk Bag labelling and coding station 204; Bulk Bag purging station 206; Bulk Bag filling station 208; Bulk Bag secure closing station 210; and Casing station 212.

At station 202, the packaging materials are received and stored. In one embodiment, the packaging materials comprise one or more of empty Bulk Bags, e.g. Bag-in-Box; labels; cartons; and any other materials needed for packaging of the refrigerated juice. The bulk bags may be of the type used in packaging of box wines, for example. The size of the bags may vary, and usually depend on the capability of the HPP facility. For instance, the bags may vary in size from 5 gallons to 50 gallons. Those of skill in the arts would appreciate that the above size range for the bulk bags is exemplary and not intended to be limiting since the controlling factor regarding the size is the capability of the HPP facility.

At station 204, the bulk bags are labelled and or coded and station 206 the bulk bags may be purged with HEPA (High Efficiency Particle Air) filtered air. At step 208, the bulk bags are filled with the juice from the juice extraction process step 114 and securely closed in step 210. Thereafter, at step 212 the securely closed bulk bags may be placed in casings, e.g. boxes, if they are not already in the boxes, for protection and for transportation to the HPP facility.

Returning back to FIG. 1, the casings containing the juice filled and secured bulk bags may be finally subjected to High Pressure Processing (HPP) at HPP Station 116. High Pressure Processing is a 5 log microbiological kill step used to ensure food safety. It is a food processing method wherein the food, already sealed in its final water-resistant packaging, is subjected to very high pressures to inactivate bacteria, yeast and mold present in the raw food. The technology can also be used to enhance desired food attributes in some foods. High pressure processing can improve food safety by inactivating the bacteria that cause food borne illness and spoilage, and parasites that cause diseases. High pressure works like heat to inactivate bacteria, yeast and mold, but the food remains fresh. In a typical process, pre-packaged fresh product is loaded inside a pressure chamber and subjected to very high pressures for specific time. This whole process may take 10 minutes or less.

HPP is a cold pasteurization technique which consists of subjecting the prepackaged food to a high level of hydrostatic pressure (i.e. pressure transmitted by water) of from 300 MPa/43,500 psi and up to 827 MPa/120,000 psi for a few seconds to a few minutes.

Thereafter, the final packaged (i.e. bulk bags) and HPP treated juice product may be shipped in refrigerated containers to remote locations 900 around the world for bottling and distribution.

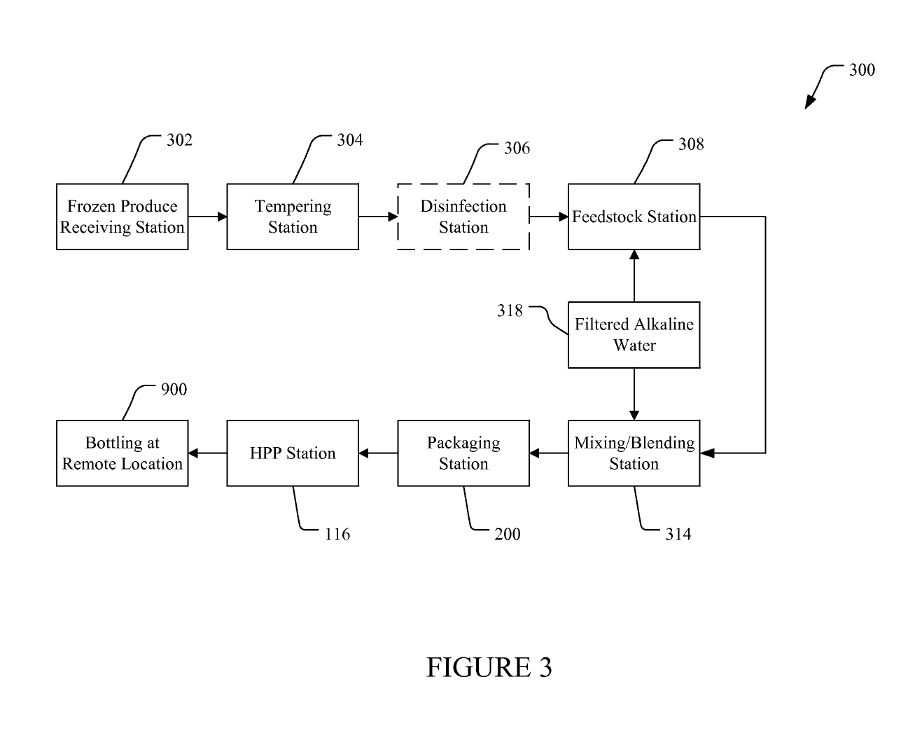

FIG. 3 is an illustration of an exemplary freeze process flow 300 for frozen goods in accordance with one or more embodiments of the present invention. As illustrated process 300 comprises frozen produce receiving station 302; tempering station 304; disinfection station 306; feedstock station 308; mixing/blending station 314; Packaging Station 200; and HPP station 116. The steps of process 300 are preferably performed in a refrigerated state.

In one or more embodiments, the receiving and handling station 302 is the initial step and generally involves receiving and maintaining frozen goods, e.g. coconut juice and meat, mango, banana, peaches, tree nuts, etc., in the frozen state, i.e. state in which it was received. For instance, frozen produce is generally received and maintained at temperatures between −10° F. and +20° F. Preferably, frozen produce is maintained at a temperature of about 0° F.

In one or more embodiments, the juice extraction assembly feeds the received produce to a tempering station 304 where the frozen produce is tempered to refrigerated temperatures, i.e. between about 30° F. and about 38° F.

In one or more embodiments of the present invention, the tempering station 304 feeds the refrigerated produce to optional disinfection station 306. The disinfection station is preferably a cold refrigerated environment. During this step, i.e. 306, the produce may be disinfected using traditional PAA (Peracetic acid) methods. Those of skill in the arts would appreciate that other methods of disinfecting the produce may be employed without deviating from the spirit of the invention.

In one or more embodiments of the present invention, the disinfection station 306 feeds the sorted produce to a feedstock station 308 for weighing, batching and mixing of the disinfected produce as needed. Filtered water 318, preferably alkaline, may be added to the produce at feedstock station 308. The weighing and batching step provides the estimated produce weight based on expected yield of raw produce for the freeze material.

In one or more embodiments of the present invention the feedstock station 308 feeds to a mixing/blending station 314. At the mixing/blending station, 314, different previously frozen produces may be mixed together, mixed with filtered water 318 or with other products, based on a formula.

In one or more embodiments of the present invention, after processing at step 314, the final freeze product may be fed to a bulk bag packaging station 200, illustrated in FIG. 2.

In one or more embodiments of the present invention, the final freeze product is fed to a bulk bag packaging station 200. As illustrated, bulk bag packaging process 200 comprises packaging material receiving station 202; Bulk Bag labelling and coding station 204; Bulk Bag purging station 206; Bulk Bag filling station 208; Bulk Bag secure closing station 210; and Casing station 212.

At station 202, the packaging materials are received and stored. In one embodiment, the packaging materials comprise one or more of: empty Bulk Bags, e.g. Bag-in-Box; labels; cartons; and any other materials needed for packaging of the final freeze product. The bulk bags may be of the type used in packaging of box wines, for example. The size of the bags may vary, and usually depend on the capability of the HPP facility. For instance, the bags may vary in size from 5 gallons to 50 gallons. Those of skill in the arts would appreciate that the above size range for the bulk bags is exemplary and not intended to be limiting since the controlling factor regarding the size is the capability of the HPP facility.

Referring back to FIG. 3, after processing at packaging station 200, the casings containing the bulk bags may be finally treated at HPP (i.e. High Pressure Processing) Station 116. Thereafter, the final packaged product, i.e. bulk bags, may be shipped in refrigerated containers to remote location 900 for bottling

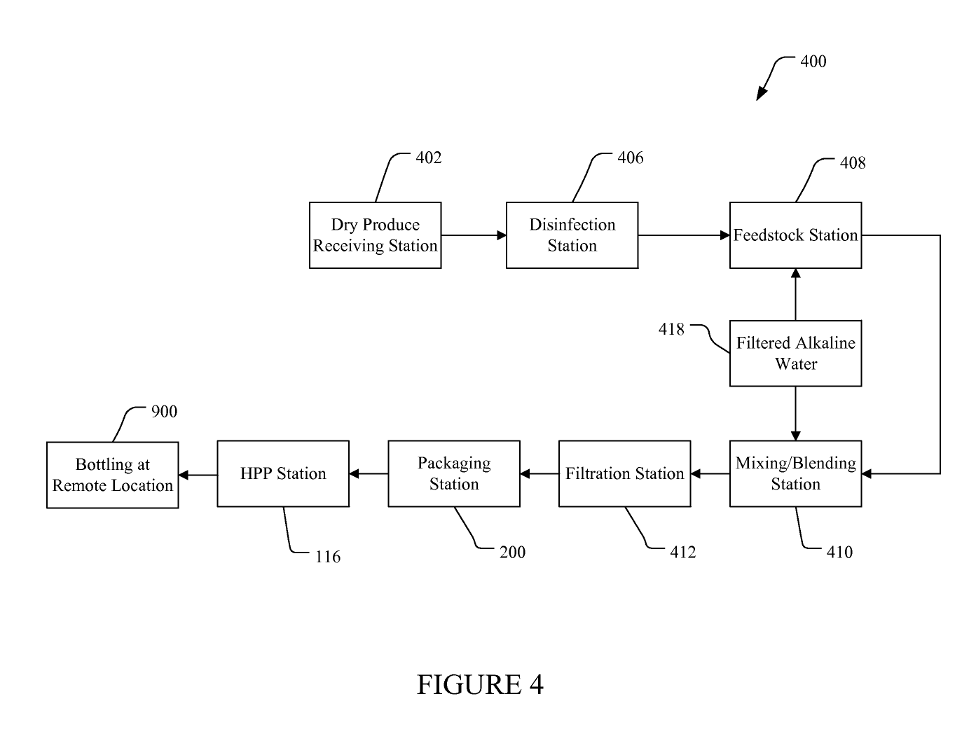

FIG. 4 is an illustration of an exemplary dry goods extraction process 400 in accordance with one or more embodiments of the present invention. As illustrated process 400 comprises dry produce receiving station 402; disinfection station 406; feedstock station 408; mixing/blending station 410; filtration station 412; bulk bag packaging station 200; and HPP station 116.

In one or more embodiments, the receiving and handling station 402 is the initial step and generally involves receiving and maintaining dry goods, e.g. tree nuts, spices, oils, extracts, and powders, in the state in which it was received. For instance, dry goods are generally received and maintained at temperatures between about 40° F. and about 85° F. Preferably, dry goods are maintained at a temperature of about 55° F. However, in one or more embodiments, nuts and dates are kept refrigerated, i.e. at temperatures between about 30° F. and about 38° F. Preferably, nuts and dates are maintained at a temperature of about 34° F.

In one or more embodiments of the present invention, the received dry goods from station 402 feeds the dry produce to optional disinfection station 406. The disinfection station is preferably a cold refrigerated environment. During this step, i.e. 406, the produce may be disinfected using traditional PAA (Peracetic acid) methods. Those of skill in the arts would appreciate that other methods of disinfecting the produce may be employed without deviating from the spirit of the invention.

In one or more embodiments of the present invention, the disinfected dry goods from station 406 feeds to a feedstock station 408 for weighing, batching and mixing of the produce as needed. Filtered water 418, preferably alkaline, may be added to the produce at feedstock station 408. The weighing and batching step provides the estimated produce weight based on expected yield for the toppings.

In one or more embodiments of the present invention, the feedstock station 408 feeds to a mixing/blending station 410. The mixing/blending station uses a specially designed nut processing skid, blend system. At the mixing/blending station 410, water may be added to the dry goods, e.g. raw nuts and dates, the mixture is disintegrated and fed to filtering station 412. The water is preferably filtered alkaline water 418. However, it should be emphasized that the nuts are not soaked, as in the prior art, because soaking may result in loss of flavor from the oils. Also, at step 410, additional ingredients may be added to complete the blend. Thus, at the mixing/blending station, 410, different dry goods may be mixed together, mixed with filtered water 418 or with other products, based on a formula to generate the desired blend.

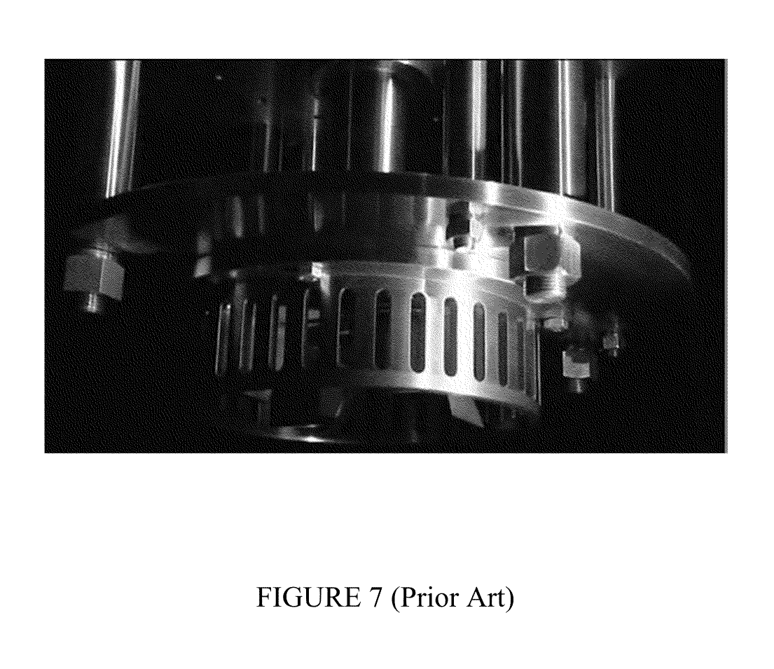

In one or more embodiments of the present invention, the mixing/blending station 410 comprises a SILVERSON GDD30 Duplex Dissolver Batch Mixer, illustrated in FIG. 7. The SILVERSON Mixer is equipped with a 30 H.P. all stainless steel motor with stainless steel lifting brackets, and upper coarse tooth disintegrating head with lower slotted head. The mixing/blending station 410 employs a special interchangeable SILVERSON rotor/stator mixing head, which allows it to be used on a wide variety of different products.

In one or more embodiments of the present invention, the mixing/blending station 410 may be cascaded with a vibratory filtering station 412. The vibratory filtering station may use various size mesh screens to filter the toppings using gravity and/or pressure. An exemplary screen for the filtering station may be a SWECO model, for instance. The filtering station may employ single or dual screen filters ranging from about 50 mesh (300 micron) to about 300 mesh (50 micron), depending on produce. In one or more embodiments, the screens may be cascaded to achieve the desired filtering clarity. In addition to the filtering with the SWECO process, a mesh sock filter may also be employed.

In one or more embodiments of the present invention, after processing at Filtration Station step 412, the final extract may be fed to a bulk bag packaging station 200, illustrated in FIG. 2.

As illustrated, bulk bag packaging process 200 comprises packaging material receiving station 202; Bulk Bag labelling and coding station 204; Bulk Bag purging station 206; Bulk Bag filling station 208; Bulk Bag secure closing station 210; and Casing station 212.

At station 202, the packaging materials are received and stored. In one embodiment, the packaging materials comprise: one or more of empty Bulk Bags, e.g. Bag-in-Box; labels; cartons; and any other materials needed for packaging of the final extract product. The bulk bags may be of the type used in packaging of box wines, for example. The size of the bags may vary, and usually depend on the capability of the HPP facility. For instance, the bags may vary in size from 5 gallons to 50 gallons. Those of skill in the arts would appreciate that the above size range for the bulk bags is exemplary and not intended to be limiting since the controlling factor regarding the size is the capability of the HPP facility.

Referring back to FIG. 4, after processing at bulk bag packaging station 200, the casings containing the secured bulk bags may be finally treated at HPP (i.e. High Pressure Processing) Station 116. Thereafter, the final packaged product, i.e. bulk bags, may be shipped in refrigerated containers to remote locations.

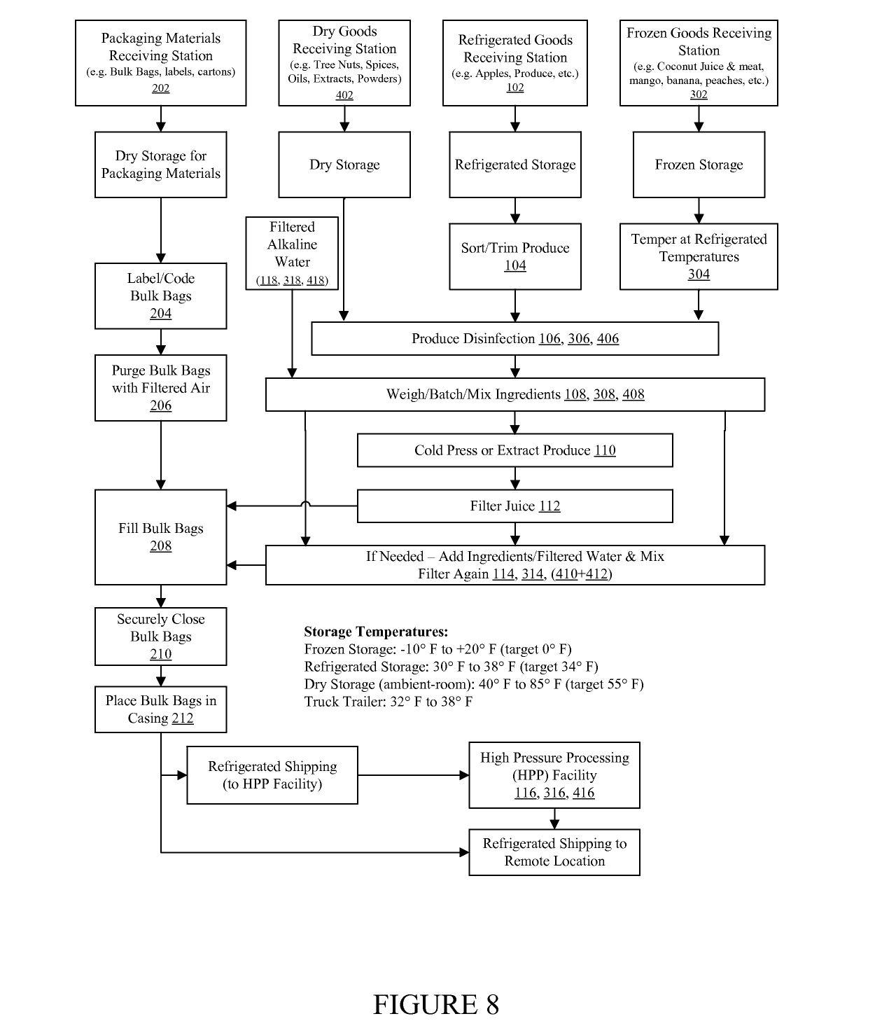

In one or more embodiments, the juice extraction process flow 100 for refrigerated goods, the freeze process flow 300 for frozen goods, the dry goods extraction process 400, or combinations thereof, may be coupled together to provide a hybrid produce processing system as illustrated in FIG. 8. As illustrated, the different embodiments of the present invention may further comprise bottling at remote location.

While the invention herein disclosed has been described by means of specific embodiments and applications thereof, numerous modifications and variations could be made thereto by those skilled in the art without departing from the scope of the invention set forth in the claims.

What is claimed is:

1. A juice extraction process comprising:
receiving produce in its delivery state;
sorting and trimming said produce;
disinfecting said produce;
using a high pressure screw press system for cold pressing said produce to extract juice;
filtering said extracted juice using one or more of gravity and pressure;
packaging said filtered juice in Bulk Bags;
subjecting said bulk bags to High Pressure Processing (HPP); and
shipping said bulk bags in refrigerated containers to remote locations.

2. The juice extraction process of claim 1, wherein said delivery state is refrigerated and each step of the juice extraction process is conducted in a refrigerated environment.

3. The juice extraction process of claim 1, wherein said disinfecting comprises disinfecting said produce using traditional PAA (Peracetic acid) methods.

4. The juice extraction process of claim 1, wherein said high pressure screw press system comprises a stainless steel single screw and twin screw press system with a large-hole screen to separate juice from pulp under pressure.

5. The juice extraction process of claim 1, wherein said filtering comprises a vibratory filtering system.

6. The juice extraction process of claim 5, wherein said vibratory filtering system employs one or more filtering screens ranging from about 50 mesh to about 300 mesh.

7. The juice extraction process of claim 6, further comprising mesh sock filtering of said extracted juice with one or more screens of about 150 mesh (100 micron).

8. The juice extraction process of claim 1, wherein said filtering step comprises a pressure and gravity filtering system.

9. A juice extraction process for refrigerated produce comprising:
receiving produce in its delivery state;
sorting and trimming said produce, wherein said sorting and trimming are performed to ensure an extracted juice meets quality specifications;
disinfecting said sorted and trimmed produce using traditional PAA (Peracetic acid) methods;
using a high pressure screw press system for cold pressing said disinfected produce to extract juice;
filtering said extracted juice using one or more of gravity and pressure;
packaging said filtered juice in Bulk Bags;
subjecting said bulk bags to High Pressure Processing (HPP); and
shipping said bulk bags in refrigerated containers to remote locations.

10. The juice extraction process of claim 9, wherein said delivery state is refrigerated and each step of the juice extraction process is conducted in a refrigerated environment.

11. The juice extraction process of claim 9, wherein said high pressure screw press system comprises a stainless steel single screw and twin screw press system with a large-hole screen to separate juice from pulp under pressure.

12. The juice extraction process of claim 9, wherein said filtering comprises a vibratory filtering system.

13. The juice extraction process of claim 12, wherein said vibratory filtering system employs one or more filtering screens ranging from about 50 mesh to about 300 mesh.

14. The juice extraction process of claim 13, further comprising mesh sock filtering of said extracted juice with one or more screens of about 150 mesh (100 micron).

15. The juice extraction process of claim 9, wherein said filtering step comprises a gravity and pressure filtering system.

16. A juice extraction process for refrigerated produce comprising:
receiving produce in its delivery state;
sorting and trimming said produce, wherein said sorting and trimming are performed to ensure an extracted juice meets quality specifications;
disinfecting said produce using traditional PAA (Peracetic acid) methods;
using a high pressure screw press system for cold pressing said produce to extract juice, wherein said high pressure screw press system comprises a stainless steel single screw and twin screw press system with a large-hole screen to separate said extracted juice from pulp under pressure;
filtering said extracted juice using a vibratory or pressure filtering system;
packaging said filtered juice in Bulk Bags;
subjecting said bulk bags to High Pressure Processing (HPP); and
shipping said bulk bags in refrigerated containers to remote locations.

17. The juice extraction process of claim 16, wherein said delivery state is refrigerated and each step of the juice extraction process is conducted in a refrigerated environment.

18. The juice extraction process of claim 17, wherein said vibratory filtering system employs one or more filtering screens ranging from about 50 mesh to about 300 mesh.

19. The juice extraction process of claim 18, further comprising mesh sock filtering of said extracted juice with one or more screens of about 150 mesh (100 micron).

20. The juice extraction process of claim 16, wherein said filtering step comprises a gravity and pressure filtering system.
